(19) United States
(12) Patent Application Publication
(10) Pub. No.: US 2021/0305859 A1
(43) Pub. Date: Sep. 30, 2021

(54) ROTOR FOR ELECTRIC MOTOR

(71) Applicant: AISIN AW CO., LTD., Anjo-shi, Aichi-ken (JP)

(72) Inventors: Yasunari FURUTA, Anjo-shi (JP); Yoshinari NAKAGAWA, Nishio-shi (JP)

(73) Assignee: AISIN AW CO., LTD., Anjo-shi, Aichi-ken (JP)

(21) Appl. No.: 16/323,342

(22) PCT Filed: Sep. 20, 2017
(86) PCT No.: PCT/JP2017/033942

§ 371 Date: Feb. 5, 2019

(30) Foreign Application Priority Data
Sep. 21, 2016 (JP) 2016-184893

(51) Int. Cl. H02K 1/27; H02K 1/28

(52) U.S. Cl. CPC H02K 1/276; H02K 29/03; H02K 1/28

(57) ABSTRACT

A rotor for an electric motor, the rotor including a rotor core that has a magnet hole that is closed in a radial direction; a permanent magnet that is disposed in the magnet hole; and an adhesive layer that is provided between the permanent magnet and a wall surface of the magnet hole.

### BACKGROUND

The present disclosure relates to a rotor for an electric motor.

There is known a technique for a rotor for an interior permanent magnet motor that includes permanent magnets that are inserted into magnet insertion holes formed in a rotor core and that are secured using an adhesive. In the rotor, grooves are formed in the inner surface of each magnet insertion hole and/or the surface of each permanent magnet so as to extend in the axial direction of the rotor core. The grooves are engageable with narrow streak members that guide insertion of the permanent magnet when the permanent magnet is inserted into the magnet insertion hole (see Japanese Patent Application Publication No. 2007-60836, for example).

### SUMMARY

With the configuration described in Japanese Patent Application Publication No. 2007-60836, however, it is necessary to insert and cut, for example, the narrow streak members to position the permanent magnet with respect to the magnet insertion hole, and thus there is problem that the manufacturing process becomes complicated.

Thus, there is a need to realize a rotor for an electric motor in which permanent magnets are positioned with respect to magnet hole portions without using narrow streak members.

In view of the above, the configuration of a rotor for an electric motor includes: a rotor core that has a magnet hole that is closed in a radial direction; a permanent magnet that is disposed in the magnet hole; and an adhesive layer that is provided between the permanent magnet and a wall surface of the magnet hole. One side of an inner side or an outer side of the radial direction is a first radial side and the other side is a second radial side. The adhesive layer is provided with respect to a wall surface on the first radial side of the magnet hole so that the permanent magnet is pushed against a wall surface on the second radial side of the magnet hole. The wall surface on the second radial side of the magnet hole includes first tapered surfaces that are connected to wall surfaces on both sides in a circumferential direction. The permanent magnet has second tapered surfaces that are in contact with the first tapered surfaces of the magnet hole. The first tapered surfaces are each longer than the second tapered surfaces, regarding a length in an axially perpendicular section that is a section perpendicular to an axial direction. The second tapered surfaces are each disposed near the second radial side of an entire area of the first tapered surface in the axially perpendicular section.

With the above configuration, it is possible to obtain the rotor for the electric motor in which the permanent magnet is positioned with respect to the magnet hole without using a narrow streak member. The second tapered surfaces of the permanent magnet are disposed near the second radial side of the entire area of the first tapered surface in the axially perpendicular section of the magnet hole. Thus, the permanent magnet may be disposed near the stator, when the stator is disposed on the second radial side with respect to the rotor.

### BRIEF DESCRIPTION OF THE DRAWINGS

FIG. 1 is a plan view illustrating a rotor according to an embodiment (first embodiment).

FIG. 2 is an explanatory view illustrating an example of a structure of an adhesive layer.

FIG. 3 illustrates the concept of states of a capsule body before and after being expanded by being heated.

FIG. 4 illustrates a state of the adhesive layer in a magnet hole portion before being expanded.

FIG. 5 illustrates a state of the adhesive layer in the magnet hole portion after being formed.

FIG. 6 illustrates a rotor that includes an adhesive layer according to a comparative example.

FIG. 7 is a plan view of a portion including a magnet hole portion of a rotor according to another embodiment (second embodiment).

FIG. 8 is a sectional view of the rotor taken along a plane that includes a center axis of the rotor according to the other embodiment (second embodiment).

FIG. 9 is a plan view of a portion of a rotor 10F according to another embodiment (third embodiment).

FIG. 10 is a partially enlarged view of FIG. 9.

FIG. 11 illustrates a different embodiment of a manner of formation of an adhesive layer in a magnet hole portion.

### DETAILED DESCRIPTION OF EMBODIMENTS

Embodiments will be described below in detail with reference to the accompanying drawings.

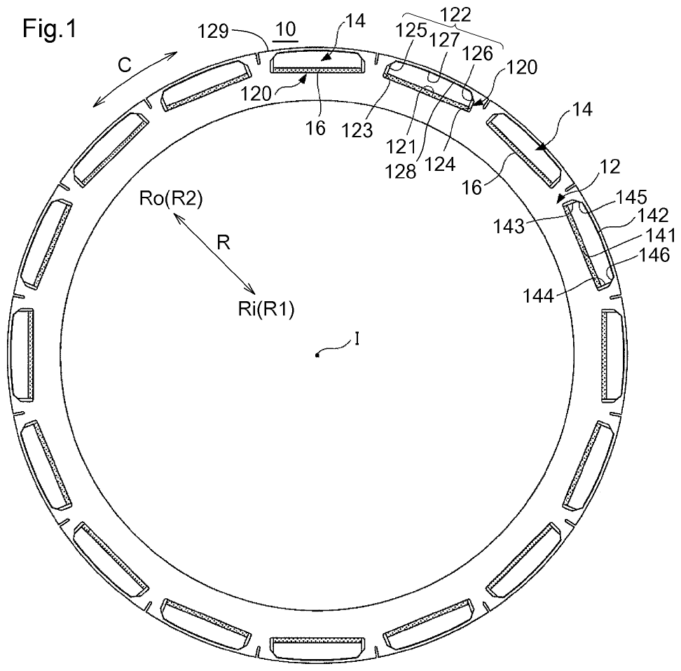

FIG. 1 is a plan view illustrating a rotor 10 according to an embodiment (first embodiment). In FIG. 1, other constituent elements (such as a shaft and end plates) that may be included in the rotor 10 are not illustrated. In the following description, unless otherwise mentioned, a radial direction R, a circumferential direction C, and an axial direction L are determined with reference to a center axis (=a rotational axis of a motor) I of the rotor 10. Adhesive layers 16 (and also adhesive layers 16F etc.) are illustrated as hatched with “fine dots” so they can be easily seen.

In the example, the rotor 10 is used in a rotary electric machine of an inner rotor type. Thus, a stator not shown is disposed on an outer radial side Ro of the rotor 10. In the present embodiment, an inner radial side Ri corresponds to a “first radial side R1” and an outer radial side Ro corresponds to a “second radial side R2”. For example, the rotor 10 may be used in a travel motor for use in a hybrid vehicle or an electric vehicle. As illustrated in FIG. 1, the rotor 10 has an annular form in plan view. The rotor 10 has a prescribed thickness in the axial direction L. That is, the rotor 10 has a form in which the annular form illustrated in FIG. 1 is continuous in the axial direction. In other words, the rotor has a cylindrical shape.

The rotor 10 includes a rotor core 12, permanent magnets 14, and adhesive layers 16.

The rotor core 12 is structured by stacking a plurality of electromagnetic steel plates in the axial direction, for example. The rotor core 12 has magnet hole portions (slot holes/magnet holes) 120. As shown in FIG. 1, a plurality of the magnet hole portions 120 are disposed side by side in the circumferential direction C. Each magnet hole portion 120 has the same shape.

The rotor core 12 is for an internal permanent magnet (IPM) motor. The magnet hole portion 120 is a hole that is closed in the radial direction R and that does not open in the radial direction R of the rotor core 12. That is, each permanent magnet 14 is not exposed to a core surface 129 that is a surface on the outer radial side Ro (second radial side R2) of the rotor core 12. Thus, as shown in FIG. 1, the core surface 129 of the rotor core 12 has a cylindrical shape that is continuous in the circumferential direction C. In the example, the magnet hole portion 120 opens only in the axial direction in both end surfaces of the rotor core 12 in the axial direction. The shape of the magnet hole portion 120 as viewed in plan (opening shape) may vary. Some examples of such shapes will be described later.

In the example shown in FIG. 1, the magnet hole portion 120 has an inner wall surface 121 that is a wall surface on the inner radial side Ri and the outer wall surface 122 that is a wall surface on the outer radial side Ro. Of these surfaces, the outer wall surface 122 includes first tapered surfaces 125 and 126 that are provided at end portions on both sides in the circumferential direction and that are connected to wall surfaces 123 and 124. In the example, the outer wall surface 122 includes an intermediate wall surface 127 that is provided between a pair of the first tapered surfaces 125 and 126 in the circumferential direction C and that faces the inner radial side Ri (first radial side R1). As described above, the core surface 129 of the rotor core 12 has a cylindrical shape that is continuous in the circumferential direction. Thus, a wall body 128 formed between the core surface 129 and the intermediate wall surface 127 of the magnet hole portion 120 is formed to be continuous in the circumferential direction C. The first tapered surfaces 125 and 126 extend in oblique directions with respect to the intermediate wall surface 127 that is a center portion of the outer wall surface 122 in the circumferential direction C and the wall surfaces 123 and 124 of both sides in the circumferential direction C. The term “first tapered surfaces” as used herein is the surface that is in contact with respective second tapered surfaces 145 and 146 of the permanent magnet 14. The first tapered surface 125 or 126 and the second tapered surface 145 or 146 are disposed in parallel. The term “in parallel” refers to when the tapered surfaces are designed so that they are disposed in parallel and include inclinations caused by manufacturing errors and assembling errors.

The first tapered surfaces 125 and 126 are longer than the second tapered surfaces 145 and 146, regarding a length in an axially perpendicular section that is a section perpendicular to the axial direction L. Thus, ideally, the contact state of the tapered surfaces that face each other is a surface contact. However, often, the contact state is a point contact. In the embodiment, the first tapered surfaces 125 and 126 and the second tapered surfaces 145 and 146 are inclined surfaces that incline to a central portion of the magnet hole portion 120 and the permanent magnet 14 in the circumferential direction C toward the outer radial side Ro (second radial side R2). Specifically, the first tapered surfaces 125 and 126 are the inclined surfaces that incline to the central portion of the magnet hole portion 120 in the circumferential direction C from portions connected to the wall surfaces 123 or 124 of both sides of the magnet hole portion 120 in the circumferential direction toward the outer radial side Ro (second radial side R2). Similarly, the second tapered surfaces 145 and 146 are inclined surfaces that incline to the central portion of the permanent magnet 14 in the circumferential direction C from portions connected to surfaces 143 and 144 on both sides of the permanent magnet 14 in the circumferential direction toward the outer radial side Ro (second radial side R2). Here, the inclined surfaces are not limited to flat surfaces and may be curved as a whole or only the end portions in the circumferential direction C may be curved. However, the “tapered surfaces” do not include surfaces that are not expected to be in surface contact with the permanent magnets 14, such as a round surface.

The permanent magnet 14 is formed from a neodymium magnet, for example. The permanent magnet 14 is disposed in the magnet hole portion 120. Here, each permanent magnet 14 is inserted in the magnet hole portion 120 to be disposed in the magnet hole portion 120. In the example, the each permanent magnet 14 has the same shape. The shape of the permanent magnets 14 as viewed in plan (sectional shape perpendicular to the axial direction L) may vary. Some examples will be described later. In the example shown in FIG. 1, the permanent magnet 14 has an inner surface 141 that is a surface on the inner radial side Ri and an outer surface 142 that is a surface on the outer radial side Ro. Of these surfaces, the outer surface 142 and surfaces 143 and 144 on both sides in the circumferential direction are connected via the second tapered surfaces 145 and 146 that extend in oblique directions with respect to the surfaces 142, 143, and 144. The second tapered surfaces 145 and 146 of the permanent magnet 14 are formed so as to be disposed in parallel along the respective first tapered surfaces 125 and 126 of the magnet hole portion 120. That is, the surfaces are formed so that an angle formed by a pair of the first tapered surfaces 125 and 126 and an angle formed by a pair of the second tapered surfaces 145 and 146 are the same angle. The permanent magnet 14 is in contact with the outer wall surface 122 only through the second tapered surfaces 145 and 146. The outer wall surface 122 is a wall surface which faces the inner radial side Ri of the magnet hole portions 120. Thus, the permanent magnet 14 and the intermediate wall surface 127 of the outer wall surface 122 are spaced away from each other. That is, a clearance 130 (see FIG. 5) is formed because the outer surface 142 of each permanent magnet 14 is spaced away from the corresponding intermediate wall surface 127 of the magnet hole portion 120. In the example, the outer surface 142 of each permanent magnet 14 is formed along the corresponding intermediate wall surface 127 of the magnet hole portion 120 so as to be spaced away by a small distance.

The adhesive layer 16 is provided between the permanent magnet 14 and the inner wall surface 121 of the magnet hole portion 120. In the example, the adhesive layer 16 is provided in such a manner as to adhere to both the permanent magnet 14 and the inner wall surface 121 of the magnet hole portion 120. The adhesive layer 16 is provided for each set of the corresponding permanent magnet 14 and magnet hole portion 120. The adhesive layers 16 for the sets have substantially the same configuration. In the example, the adhesive layer 16 fixes the corresponding permanent magnet 14 to the inner wall surface 121 of the magnet hole portion 120 which faces the permanent magnet 14. Additionally, in the example, the adhesive layer 16 is provided to extend over the entirety of the corresponding permanent magnet 14 and magnet hole portion 120 in the axial direction. Hereinafter, focus is placed on one of the magnet hole portions 120, and the one of the magnet hole portions 120 and the permanent magnet 14 and the adhesive layer 16 which are provided for the one magnet hole portion 120 will be described.

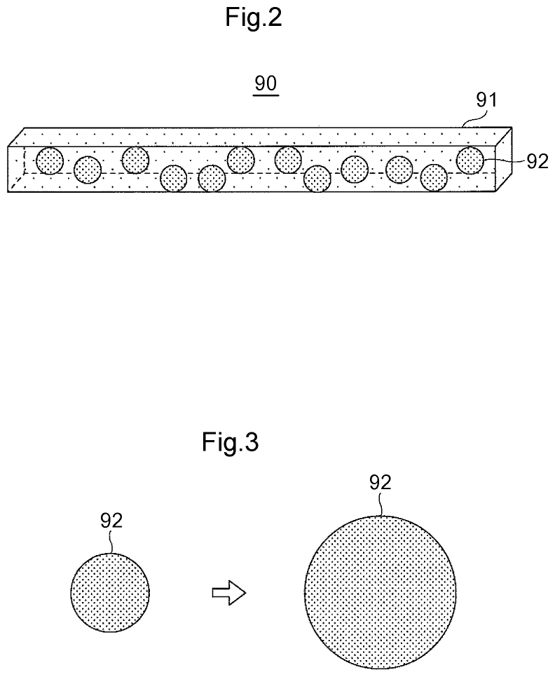

FIG. 2 illustrates the structure of the adhesive layer 16, and is a perspective view illustrating the concept of an adhesive 90 in a simple state (sheet-like state) before being heated. FIG. 3 illustrates the concept of states of a capsule body 92 before and after being expanded by being heated.

The adhesive layer 16 contains a material that expands under predetermined conditions. In the embodiment, the adhesive layer 16 is formed by heating the adhesive 90 compounded with multiple capsules that are expanded when heated. In the example illustrated in FIG. 2, the adhesive 90 is an epoxy resin 91 compounded with multiple capsule bodies 92 that are expanded when heated. When heated, the capsule body 92 is expanded from the state before being heated illustrated on the left side of FIG. 3 to the state after being heated illustrated on the right side of FIG. 3. As a result, the entire adhesive 90 is expanded when heated so that the adhesive layer 16 is formed after being heated (after being cured). The capsule bodies 92 which have been present since before being heated remain as expanded capsule bodies in the adhesive layer 16 also after being heated.

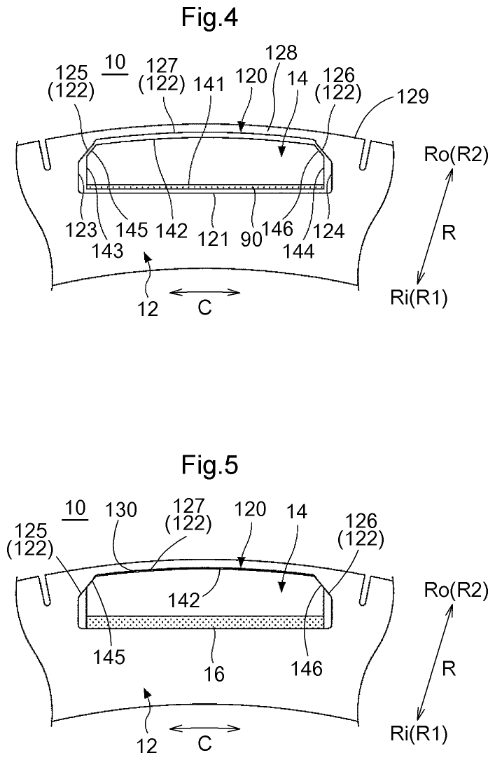

FIG. 4 illustrates a state of the adhesive layer 16 (adhesive 90) in the magnet hole portion 120 before expansion, and illustrates a state in which the permanent magnet 14 to which the adhesive 90 before being heated has been applied or affixed is inserted in the magnet hole portion 120. FIG. 5 illustrates a state of the adhesive layer 16 in the magnet hole portion 120 after it is formed, and illustrates a state in which the adhesive layer 16 after the adhesive 90 was heated is formed.

As illustrated in FIG. 4, the permanent magnet 14 to which the adhesive 90 has been applied or affixed (hereinafter, representatively expressed as “applied”) is inserted into the magnet hole portion 120 in the axial direction. In the embodiment, the adhesive 90 has been applied only to the inner surface 141 of the permanent magnet 14 (the surface which faces the inner wall surface 121 of the magnet hole portion 120). When heating processing is performed in the state before expansion as shown in FIG. 4, the adhesive 90 expands and the adhesive layer 16 is formed as shown in FIG. 5.

Here, in the heating processing, the inner radial side of the adhesive layer 16 contacts the inner wall surface 121 of the magnet hole portion 120 through expansion of the adhesive 90. When the adhesive 90 is further expanded, a force toward the outer radial side Ro is mainly applied to the permanent magnet 14 in the magnet hole portion 120. Thus, in the course of the expansion of the adhesive 90, the permanent magnet 14 in the magnet hole portion 120 is moved toward the outer wall surface 122 of the magnet hole portion 120. The permanent magnet 14 is pushed against the outer wall surface 122 of the magnet hole portion 120. That is, the adhesive layer 16 pushes the permanent magnet 14 against the outer wall surface 122 of the magnet hole portion 120. Here, when the permanent magnet 14 is moved toward the outer wall surface 122, the second tapered surfaces 145 and 146 of the permanent magnet 14 are in contact with the first tapered surfaces 125 and 126, respectively, of the magnet hole portion 120. Thus, the permanent magnet 14 is guided along the tapered surfaces 125 and 126 of the magnet hole portion 120. As a result, the permanent magnet 14 is positioned in the circumferential direction C and the radial direction R with respect to the magnet hole portion 120. That is, the permanent magnet 14 is fixed with respect to the rotor core 12 with the second tapered surfaces 145 and 146 extending along (in contact with) the first tapered surfaces 125 and 126 of the magnet hole portion 120. The clearance 130 is formed between the outer surface 142 of the permanent magnet 14 and the intermediate wall surface 127 of the outer wall surface 122 of the magnet hole portion 120. Thus, the permanent magnet 14 is in contact with the wall surface which faces the inner radial side Ri of the magnet hole portion 120, only through the second tapered surfaces 145 and 146. Therefore, the function of the first tapered surfaces 125 and 126 of the outer wall surface 122 of positioning the permanent magnet 14 can be enhanced.

In the example, the wall surface which faces the inner radial side Ri (first radial side R1) of the magnet hole portion 120 is the outer wall surface 122, that is structured by the first tapered surfaces 125 and 126 and the intermediate wall surface 127 which is between the first tapered surfaces 125 and 126 in the circumferential direction C. In the embodiment, as shown in FIG. 5, the second tapered surfaces 145 and 146 are disposed near the outer radial side Ro of the entire area of the first tapered surfaces 125 and 126 in the axially perpendicular section. Thus, the permanent magnet 14 may be disposed near the stator disposed on the outer radial side Ro with respect to the rotor 10. Therefore, it is possible to make a structure in which a torque of the electric motor can be easily increased.

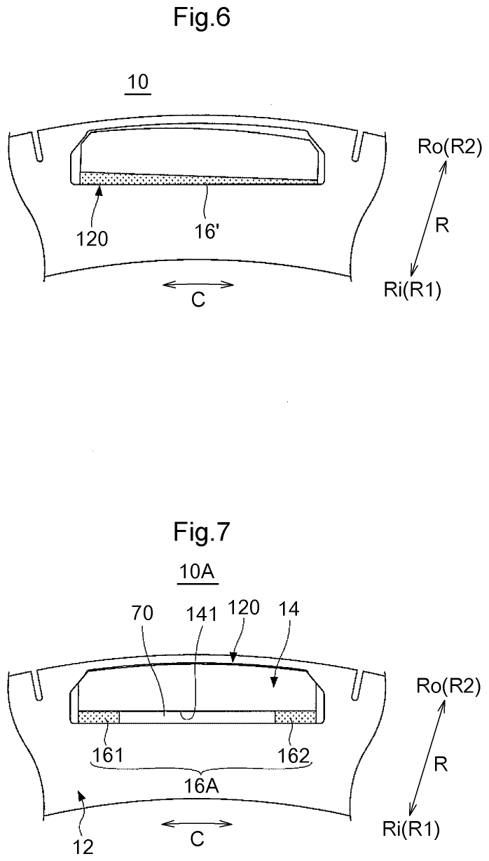

FIG. 6 illustrates a rotor that includes an adhesive layer 16′ according to a comparative example. In the comparative example, the adhesive layer 16′ is formed using an adhesive not compounded with the capsule bodies 92. With such a comparative example, as illustrated in FIG. 6, a clearance may be formed between a wall surface of the magnet hole portion 120 on the outer radial side Ro and the permanent magnet because of dripping of the adhesive during curing processing or the like, and the permanent magnet cannot be positioned with respect to the magnet hole portion. Additionally, when the adhesive reaches the outer radial side of the permanent magnet and is fixed, there are cases in which the permanent magnet cannot be put close to the stator.

In this respect, with the embodiment in which the adhesive 90 which is expandable is used, individual differences for the clearance in the radial direction R between the center portion, in the circumferential direction C, of the outer wall surface 122 of the magnet hole portion 120 and the permanent magnet 14 can be reduced as illustrated in FIG. 5, even if the thickness of the adhesive 90 in the applied state is not uniform. In addition, as discussed above, the permanent magnet 14 can be fixed by being positioned in a state in which the permanent magnet 14 is pushed against the outer wall surface 122 of the magnet hole portion 120 by use of expansion of the adhesive 90. As a result, motor torque fluctuations, variations, and so forth due to fluctuations in positions of the permanent magnets 14 in the respective magnet hole portions 120 can be reduced.

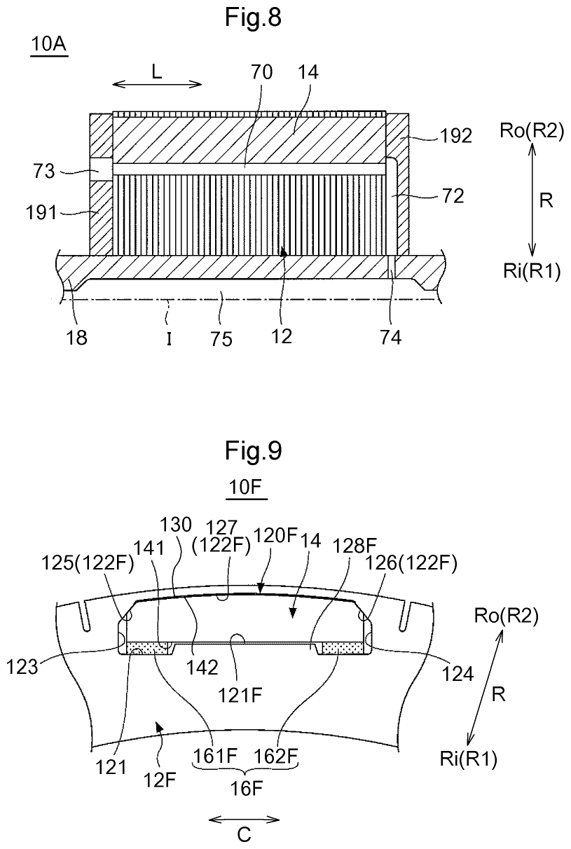

Next, a rotor 10A according to another embodiment (second embodiment) will be described with reference to FIGS. 7 and 8.

The rotor 10A according to the second embodiment mainly differs from the rotor 10 according to the first embodiment discussed above in that the adhesive layer 16 has been replaced with an adhesive layer 16A and that oil passages 74, 73, and 72 are formed in a shaft 18 and end plates 191 and 192, respectively. Hereinafter, constituent elements that are the same as those of the rotor 10 according to the first embodiment discussed above are given the same reference numerals to omit description.

FIG. 7 is a plan view of a portion of the rotor 10A that includes one magnet hole portion 120. FIG. 8 is a sectional view of the rotor 10A taken along a plane that includes the center axis I of the rotor 10A, illustrating only half of the rotor 10A on one side with respect to the center axis I of the rotor 10A.

The adhesive layer 16A is the same as the adhesive layer 16 according to the first embodiment discussed above except for the location of formation. Thus, the adhesive layer 16A is formed by heating a material that expands under predetermined conditions, such as an adhesive compounded with capsules that are expanded when heated.

The adhesive layer 16A forms an oil passage 70 between both ends of the permanent magnet 14 in the circumferential direction C. The oil passage 70 is blocked on both ends in the circumferential direction C. Specifically, the adhesive layer 16A includes a first adhesive layer 161 and a second adhesive layer 162. The first adhesive layer 161 is provided at one end area, in the circumferential direction C, of the inner surface 141 of the permanent magnet 14. The second adhesive layer 162 is provided at the other end area, in the circumferential direction C, of the inner surface 141. The first adhesive layer 161 and the second adhesive layer 162 are provided to extend over the entire permanent magnet 14 in the axial direction L. The first adhesive layer 161 and the second adhesive layer 162 are disposed apart from each other in the circumferential direction C. The oil passage 70 is formed between the first adhesive layer 161 and the second adhesive layer 162 in the circumferential direction C. As illustrated in FIG. 8, the oil passage 70 opens at both ends of the rotor core 12 in the axial direction, and communicates with the oil passages 73 and 72 in the end plates 191 and 192, respectively.

The end plate 191 is provided around the shaft 18 so as to cover an end surface of the rotor 10A on one end side in the axial direction. The end plate 192 is provided around the shaft 18 so as to cover an end surface of the rotor 10A on the other end side in the axial direction. The end plate 191 has the oil passage 73 which is formed so as to extend through the end plate 191 in the axial direction at each position corresponding to the oil passage 70. The end plate 192 has the oil passage 72 which is formed so as not to extend through the end plate 192 in the axial direction at each position corresponding to the oil passage 70. As illustrated in FIG. 8, the oil passage 72 extends in the radial direction R, and communicates with the corresponding oil passage 74 which is formed in the shaft 18. The oil passage 72 may be formed in such a manner as to extend radially from the center axis I side as viewed in the axial direction.

An oil passage 75 which is a hollow portion is formed in the shaft 18. The oil passage 75 extends in the axial direction. The oil passage 74 extends in the radial direction R, and allows communication of the oil passage 72 and the oil passage 75.

When the rotor 10A is rotated during operation of the rotor 10A, oil in the oil passage 75 flows to the outer radial side Ro through the oil passage 74 and the oil passage 72 by action of centrifugal force or discharge pressure. After that, the oil flows in the axial direction through the oil passage 70, and flows further downstream via the oil passage 73. When the oil passes through the oil passage 70, the permanent magnet 14 is cooled. In this way, the permanent magnet 14 can be cooled by forming the oil passage 70 using the adhesive layer 16A.

In this way, with the second embodiment, in addition to the effect according to the first embodiment discussed above, the permanent magnet 14 can be cooled by forming the oil passage 70 using the adhesive layer 16A. The oil passage 70 is blocked by the first adhesive layer 161 and the second adhesive layer 162 on both sides in the circumferential direction, and blocked by the permanent magnet 14 on the outer radial side Ro. Thus, leakage of oil flowing in the oil passage 70 can be reduced.

In the case where the oil passage is formed by the rotor core 12 which is formed from stacked steel sheets, oil may leak to the outer radial side Ro through gaps between stacked plates of the rotor core 12. In the case where the adhesive layer 16A is provided on the outer radial side Ro, rather than the inner radial side Ri, with respect to the permanent magnet 14, for example, oil may leak to the outer radial side Ro through gaps between the stacked plates of the rotor core 12. With the second embodiment, in contrast, the oil passage 70 is blocked by the permanent magnet 14 on the outer radial side Ro, and thus it is possible to effectively prevent oil from leaking to the outer radial side Ro because of the centrifugal force.

Next, a rotor 10F according to another embodiment (third embodiment) will be described with reference to FIG. 9. FIG. 9 is a plan view of a portion of the rotor 10F that includes one magnet hole portion 120F.

The rotor 10F illustrated in FIG. 9 is different from the rotor 10 according to the first embodiment discussed above in that the rotor core 12 has been replaced with a rotor core 12F and the adhesive layer 16 has been replaced with an adhesive layer 16F. Hereinafter, constituent elements that are the same as those of the rotor 10 according to the first embodiment discussed above are given the same reference numerals to omit description.

The rotor core 12F is different from the rotor core 12 according to the first embodiment discussed above in that a projecting portion 128F is formed in the magnet hole portion 120F. The projecting portion 128F is provided on an inner wall surface 121F that is a wall surface on the inner radial side Ri of the magnet hole portion 120F. The projecting portion 128F projects in the radial direction R toward the center portion of the permanent magnet 14 in the circumferential direction C. That is, the projecting portion 128F faces, in the radial direction R, the center portion of the permanent magnet 14 in the circumferential direction C, and does not face, in the radial direction R, the end portions of the permanent magnet 14 in the circumferential direction C. The projecting portion 128F is provided to extend over the entire rotor core 12F in the axial direction L. A clearance in the radial direction R between the projecting portion 128F and the center portion of the permanent magnet 14 in the circumferential direction C may be a minimum clearance required to assemble the permanent magnet 14 to the magnet hole portion 120F.

The adhesive layer 16F is the same as the adhesive layer 16 according to the first embodiment discussed above except for the location of formation. Thus, the adhesive layer 16F is formed by heating a material that expands under predetermined conditions, such as an adhesive compounded with capsules that are expanded when heated.

The adhesive layer 16F is provided at both ends of the permanent magnet 14 in the circumferential direction C with a space therebetween in the circumferential direction C.

Specifically, the adhesive layer 16F includes a first adhesive layer 161F and a second adhesive layer 162F. The first adhesive layer 161F is provided at one end area, in the circumferential direction C, of the inner wall surface 121F of the magnet hole portion 120F. The second adhesive layer 162F is provided at the other end area, in the circumferential direction C, of the inner wall surface 121F. The first adhesive layer 161F and the second adhesive layer 162F are provided to extend over the entire permanent magnet 14 in the axial direction L. The first adhesive layer 161F and the second adhesive layer 162F are disposed apart from each other in the circumferential direction C. The projecting portion 128F is positioned between the first adhesive layer 161F and the second adhesive layer 162F in the circumferential direction C. In other words, the first adhesive layer 161F and the second adhesive layer 162F are provided on the outer side in the circumferential direction C with respect to the projecting portion 128F. That is, the first adhesive layer 161F and the second adhesive layer 162F are disposed on both sides of the projecting portion 128F in the circumferential direction C with the projecting portion 128F therebetween.

With the example illustrated in FIG. 9, an effect that is similar to that of the first embodiment discussed above can be obtained. That is, due to the expansion of the adhesive when forming the adhesive layer 16F, the permanent magnet 14 is in contact with the first tapered surfaces 125 and 126 of the outer wall surface 122F of the magnet hole portion 120F (see FIG. 4 and FIG. 5) and is positioned in the circumferential direction C and the radial direction R. Therefore, the permanent magnet 14 is fixed by being positioned with respect to the magnet hole portion 120F.

Specifically, in the example, a portion of the inner radial side Ri of the adhesive layer 16F is in contact with the inner wall surface 121F of the magnet hole portion 120F through expansion of the adhesive 90, similar to the first embodiment illustrated in FIG. 4 and FIG. 5. When the adhesive 90 is further expanded, a force toward the outer radial side Ro is mainly applied to the permanent magnet 14 in the magnet hole portion 120F. Thus, in the course of the expansion of the adhesive 90, the permanent magnet 14 in the magnet hole portion 120F is moved toward the outer wall surface 122F of the magnet hole portion 120F. The permanent magnet 14 is pushed against the outer wall surface 122F of the magnet hole portion 120F. That is, the adhesive layer 16 pushes the permanent magnet 14 against the outer wall surface 122F of the magnet hole portion 120F. Here, when the permanent magnet 14 is moved toward the outer wall surface 122F, the second tapered surfaces 145 and 146 of the permanent magnet 14 are in contact with the first tapered surfaces 125 and 126, respectively, of the magnet hole portion 120F. Thus, the permanent magnet 14 is aligned and guided along the tapered surfaces 125 and 126 of the magnet hole portion 120F. As a result, the permanent magnet 14 is positioned in both the circumferential direction C and the radial direction R with respect to the magnet hole portion 120F. That is, the permanent magnet 14 is fixed with respect to the rotor core 12 with the second tapered surfaces 145 and 146 extending along (in contact with) the first tapered surfaces 125 and 126 of the magnet hole portion 120F. The clearance 130 is formed between the outer surface 142 of the permanent magnet 14 and the intermediate wall surface 127 that is the center portion of the outer wall surface 122F of the magnet hole portion 120F in the circumferential direction C. Thus, the permanent magnet 14 is in contact with a wall surface which faces the inner radial side Ri of the magnet hole portion 120F, only through the second tapered surfaces 145 and 146. Therefore, the function of the first tapered surfaces 125 and 126 of the outer wall surface 122F of positioning the permanent magnet 14 can be enhanced. In the example, the outer wall surface 122F that is the wall surface that faces the inner radial side Ri (first radial direction R1) of the magnet hole portion 120F is structured by the intermediate wall surface 127 and the first tapered surfaces 125 and 126.

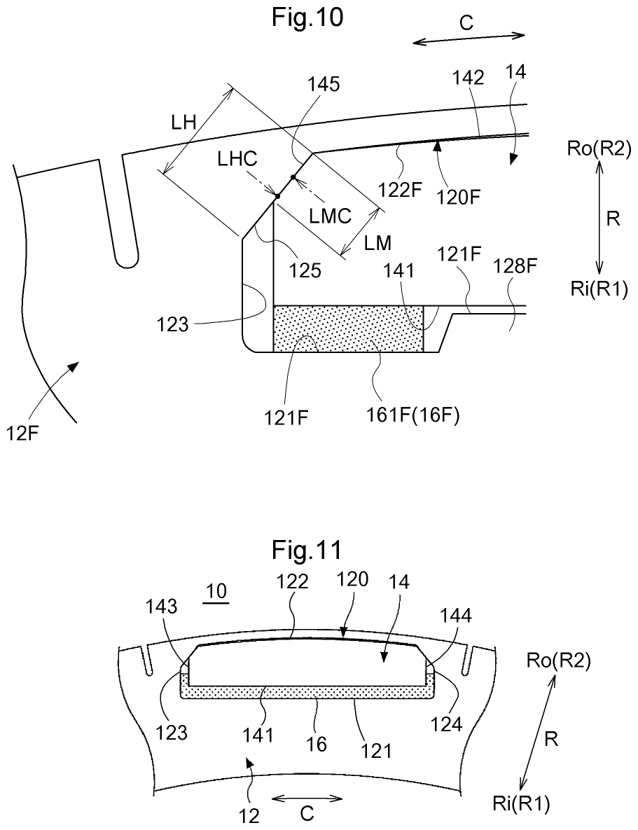

As shown enlarged in FIG. 10, in the example, a length LH of the first tapered surfaces 125 and 126 of the magnet hole portion 120F is longer than a length LM of the second tapered surfaces 145 and 146 of the permanent magnet 14, regarding the length in the axially perpendicular section that is the section perpendicular to the axial direction L. The second tapered surfaces 145 and 146 are disposed near the outer radial side Ro (second radial side R2) of the entire area of the first tapered surfaces 125 and 126 in the axially perpendicular section. That is, a middle position LMC of the length LM of the second tapered surfaces 145 and 146 in the axially perpendicular section is disposed near the outer radial side Ro (second radial side R2) than a middle position LHC of the length LH of the entire area of the first tapered surfaces 125 and 126 in the axially perpendicular section. Thus, the permanent magnet 14 may be disposed near the stator disposed on the outer radial side Ro with respect to the rotor. Therefore, it is possible to make a structure in which a torque of the electric motor can be easily increased.

In general, magnetic saturation tends to be caused at positions corresponding to both ends of the magnet hole portion 120F in the circumferential direction C, among positions of the rotor core 12F in the circumferential direction C, more than at a position corresponding to the center portion of the magnet hole portion 120F in the circumferential direction C. That is, magnetic saturation tends to be caused in a region of the rotor core 12F that is close to end portions of the magnet hole portion 120F in the circumferential direction C.

In this respect, in the example illustrated in FIG. 9, the rotor core 12F includes the projecting portion 128F at a position corresponding to the center portion of the magnet hole portion 120F in the circumferential direction C. Consequently, a magnetic resistance can be reduced and, as a result, the torque properties of the electric motor can be improved, compared to when the projecting portion 128F is not provided. With the example illustrated in FIG. 9, in addition, the magnetic resistance can be reduced efficiently compared to when similar projecting portions are provided at positions corresponding to both ends of the magnet hole portion in the circumferential direction C. This is because magnetic saturation tends to be caused at positions corresponding to both ends of the magnet hole portion 120F in the circumferential direction C as discussed above.

In this way, with the example illustrated in FIG. 9, a magnetic flux of the permanent magnet 14 can easily go through a region in which magnetic saturation does not tend to be caused, by providing the projecting portion 128F in a region in which magnetic saturation does not tend to be caused in the circumferential direction C while providing the adhesive layer 16F in a region in which magnetic saturation tends to be caused in the circumferential direction C. Thus, the magnetic resistance of the entire rotor core 12F can be reduced efficiently while the effect of the adhesive layer 16F discussed above is obtained.

Although the embodiments have been discussed in detail above, the present disclosure is not limited to specific embodiments, and a variety of modifications and changes may be made without departing from the scope of the disclosure. In addition, all or a plurality of the constituent elements according to the embodiments discussed earlier may be combined with each other.

For example, in the first embodiment described above, the first tapered surface 125 is formed to be continuous with the intermediate wall surface 127 of the center portion of the outer wall surface 122 in the circumferential direction C. However, another surface may be interposed between the intermediate wall surface 127 and the tapered surface 125. The same also applies to the other first tapered surface 126.

In each of the embodiments discussed above, the present disclosure is applied to the rotor 10 of the inner rotor type. However, the present disclosure may also be applied to a rotor 10 of an outer rotor type. In the case of the rotor 10 of the outer rotor type, basically, the arrangement of the components is simply flipped in the radial direction R. In this case, the inner radial side Ri is the “second radial direction R2” and the outer radial side Ro is the “first radial direction R1”.

The cooling structure according to the second embodiment may be applied to the embodiment illustrated in FIG. 9. That is, the oil passage 70 may be formed between the first adhesive layer 161F and the second adhesive layer 162F. The oil passage 70 may otherwise be formed in the projecting portion 128F of the magnet hole portion 120F. In this case, a recessed groove, that is recessed toward the inner radial side Ri and that extends in the axial direction L, may be formed on the center portion of the projecting portion 128F in the circumferential direction C. However, in order to reduce the magnetic resistance and as a result improve the torque characteristics of the electric motor, the projecting portion 128F should be brought closer to the permanent magnet 14 as much as possible. For the same reasons, the length of the projecting portion 128F in the circumferential direction should be increased. As a result, in the example illustrated in FIG. 9, the first adhesive layer 161F and the second adhesive layer 162F are disposed at positions at which the first adhesive layer 161F and the second adhesive layer 162F overlap with the second tapered surfaces 145 and 146, respectively, when viewed in the radial direction R.

In the embodiments described above, the adhesive layers 16, 16F are provided only with respect to the inner wall surfaces 121, 121F (wall surfaces on the first radial side R1) of the magnet hole portions 120, 120F. However, the adhesive layers 16, 16F are not limited to this, and may be provided on portions other than the inner wall surfaces 121, 121F (wall surfaces on the first radial side R1) of the magnet hole portions 120, 120F. For example, as illustrated in FIG. 11, the adhesive layer 16 may be provided on the wall surfaces 123 and 124 on both sides in the circumferential direction in addition to the inner wall surface 121 (wall surface on the first radial side R1) of the magnet hole portion 120. That is, the adhesive layer 16 should be able to push the permanent magnet 14 against the outer wall surface 122 (wall surface on the second radial side R2) of the magnet hole portion 120. In the example illustrated in FIG. 11, the adhesive layer 16 is provided between the surfaces 143 and 144 on both sides of the permanent magnet 14 in the circumferential direction and the wall surfaces 123 and 124 on both sides of the magnet hole portion 120 in the circumferential direction, respectively, as well as between the inner surface 141 of the permanent magnet 14 and the inner wall surface 121 of the magnet hole portion 120.

A summary of the rotor (10, 10A, 10F) for the electric motor described above will be described below.

The rotor (10, 10A, 10F) for the electric motor includes: the rotor core (12, 12F) that has the magnet hole portion (120, 120F) that is closed in the radial direction (R); the permanent magnet (14) disposed in the magnet hole portion (120, 120F); and the adhesive layer (16, 16A, 16F) that is provided between the permanent magnet (14) and the wall surface of the magnet hole portion (120, 120F), in which one side of the inner side or the outer side in the radial direction (R) is the first radial side (R1) and the other side is the second radial side (R2), the adhesive layer (16, 16A, 16F) is only provided with respect to the wall surface (121, 121F) on the first radial side (R1) of the magnet hole portion (120, 120F) and pushes the permanent magnet (14) against the wall surface (122, 122F) of the second radial side (R2) of the magnet hole portion (120, 120F), the wall surface (122, 122F) on the second radial side (R2) of the magnet hole portion (120, 120F) includes the first tapered surfaces (125, 126) that are connected to the wall surfaces (121, 121) on both sides in the circumferential direction, the permanent magnet (14) has the second tapered surfaces (145, 146) that are in contact with the first tapered surfaces (125, 126) of the magnet hole portion (120, 120F), the first tapered surfaces (125, 126) are each longer than the second tapered surfaces (145, 146), regarding the length in the axially perpendicular section that is the section perpendicular to the axial direction (L), and the second tapered surfaces (145, 146) are each disposed near the second radial direction (R2) of the entire area of the first tapered surfaces (125, 126) in the axially perpendicular section.

With the above configuration, it is possible to obtain a rotor for an electric motor in which a permanent magnet is positioned with respect to a magnet hole portion without using narrow streak members. Specifically, the permanent magnet is pushed against the wall surface on the second radial side of the magnet hole portion while the second tapered surfaces of the permanent magnet are guided along the first tapered surfaces of the magnet hole portion. Thus, the permanent magnet is positioned in the circumferential direction and the radial direction with respect to the magnet hole portion. The second tapered surfaces of the permanent magnet are disposed near the second radial side of the entire area of the first tapered surfaces in the axially perpendicular section of the magnet hole portion. Thus, the permanent magnet may be disposed near the stator, when the stator is disposed on the second radial side with respect to the rotor.

Here, it is preferable that the permanent magnet (14) be in contact with only the second tapered surfaces (145, 146) with respect to the wall surface that faces the first radial side (R1) of the magnet hole portion (120, 120F).

With this configuration, the permanent magnet is positioned with respect to the magnet hole portion by only the second tapered surfaces that are in contact with the first tapered surfaces of the magnet hole portion. Thus, it is possible to surely demonstrate a function of the first tapered surfaces of positioning the permanent magnet in both the circumferential direction and the radial direction.

Preferably, the wall surface (122, 122F) on the second radial side (R2) of the magnet hole portion (120, 120F) includes the intermediate wall surface (127) that is between the pair of the first tapered surfaces (125, 126) in the circumferential direction (C) and that faces the first radial side (R1), and the permanent magnet (14) and the intermediate wall surface (127) are spaced away from each other.

With this configuration, the permanent magnet is not in contact with the intermediate wall surface. Thus, the function of positioning the permanent magnet by having the second tapered surfaces of the permanent magnet be in contact with the first tapered surfaces of the magnet hole portion is not inhibited by the permanent magnet being in contact with the intermediate wall surface. Thus, it is possible to surely demonstrate the function of the first tapered surfaces of positioning the permanent magnet in both the circumferential direction and the radial direction.

Preferably, the core surface (129) that is the surface on the second radial side (R2) of the rotor core (12, 12F) has the cylindrical shape, and the wall body (128) that is continuous in the circumferential direction (C) is formed between the core surface (129) and the intermediate wall surface (127).

With this configuration, it is easier to increase the reliability of holding the permanent magnet with respect to the rotor core 12, compared to when there is no such wall body and the permanent magnet is exposed to the surface on the second radial side of the rotor core. It is also possible to suppress fluctuation of how easily the magnetic flux passes in the circumferential direction, on the surface on the second radial side of the rotor core, compared to when there is no such wall body. Cogging torque of the electric motor can thus be reduced.

1. A rotor for an electric motor, the rotor comprising:
a rotor core that has a magnet hole that is closed in a radial direction;
a permanent magnet that is disposed in the magnet hole; and
an adhesive layer that is provided between the permanent magnet and a wall surface of the magnet hole, wherein
one side of an inner side or an outer side of the radial direction is a first radial side and the other side is a second radial side,
the adhesive layer is provided with respect to a wall surface on the first radial side of the magnet hole so that the permanent magnet is pushed against a wall surface on the second radial side of the magnet hole,
the wall surface on the second radial side of the magnet hole includes first tapered surfaces that are connected to wall surfaces on both sides in a circumferential direction,
the permanent magnet has second tapered surfaces that are in contact with the first tapered surfaces of the magnet hole,
the first tapered surfaces are each longer than the second tapered surfaces, regarding a length in an axially perpendicular section that is a section perpendicular to an axial direction, and
the second tapered surfaces are each disposed near the second radial side of an entire area of the first tapered surfaces in the axially perpendicular section.

2. The rotor for the electric motor according to claim 1, wherein
the permanent magnet is in contact with a wall surface facing the first radial side of the magnet hole only through the second tapered surfaces.

3. The rotor for the electric motor according to the claim 1, wherein
the wall surface on the second radial side of the magnet hole includes an intermediate wall surface that is between a pair of the first tapered surfaces in the circumferential direction and faces the first radial side, and
the permanent magnet and the intermediate wall surface are spaced away from each other.

4. The rotor for the electric motor according to claim 3, wherein
a core surface that is a surface on the second radial side of the rotor core has a cylindrical shape, and
a wall that is continuous in the circumferential direction is formed between the core surface and the intermediate wall surface.
